(19) United States
(12) Patent Application Publication
(10) Pub. No.: US 2014/0355573 A1
(43) Pub. Date: Dec. 4, 2014

(54) SHARING UP-LINK RESOURCES IN UNIVERSAL MOBILE TELECOMMUNICATIONS SYSTEM

(71) Applicants: Shin Horng Wong, Swindon (GB); Vikas Dhingra, Bangalore (IN)

(72) Inventors: Shin Horng Wong, Swindon (GB); Vikas Dhingra, Bangalore (IN)

(73) Assignee: ALCATEL LUCENT, Paris (FR)

(21) Appl. No.: 14/238,420

(22) PCT Filed: Jul. 4, 2012
(86) PCT No.: PCT/EP2012/063013

§ 371 Date: May 27, 2014

(30) Foreign Application Priority Data
Aug. 12, 2011 (IN) 2304/DEL/2011

(51) Int. Cl. H04W 72/04; H04W 74/08

(52) U.S. Cl. CPC H04W 72/0406; H04W 74/0833
USPC 370/336

(57) ABSTRACT

The present subject matter discloses a method for sharing a enhanced uplink dedicated channel (E-DCH) resource from amongst a plurality of E-DCH resources on time multiplex basis. In one implementation, the method comprises receiving, from a user equipment (UE), a random access procedure (RAP) request for allocation of the common E-DCH resource from amongst a plurality of common E-DCH resources. The method further includes identifying the common E-DCH resource to be time multiplexed between a plurality of UEs based on the RAP request. The method also includes allocating the identified common E-DCH resource to the UE on a time multiplex basis, wherein the common E-DCH resource is shared among the plurality of UEs.

### FIELD OF INVENTION

The present subject matter relates to communication systems and, particularly, but not exclusively, to Universal Mobile Telecommunications Systems (UMTS).

### BACKGROUND

Communication devices, such as cellular phones, personal digital assistants, portable computers, and desktop computers, provide users with a variety of mobile communications services and computer networking capabilities. These communications services allow data to be exchanged between the service providers and the users. Mobile radio network operators currently have the option of operating not only the prevalent mobile radio systems using the GSM standard, but also networks using the new and evolved Universal Mobile Telecommunications Service (UMTS) standard. UMTS is a third-generation (3G) broadband standard based on the Global System for Mobile (GSM) implementing packet-based transmission of text, digitized voice, video, and multimedia at data rates up to several megabits per second (Mbps). UMTS offers a consistent set of services to mobile computer and phone users, no matter where they are located in the world. UMTS conforms to standards set by 3rd Generation Partnership Project (3GPP). Over time, several releases of 3GPP standards for UMTS have imparted various features to the UMTS

UMTS employs the High Speed Packet Access (HSPA) technique. HSPA refers to the combination of high speed downlink packet access (HSDPA) and high speed uplink packet access (HSUPA) enabling higher data exchange capabilities and improving the total throughput of the network. The 3GPP release 7 introduced Enhanced CELL_FACH feature to the UMTS. Enhanced CELL_FACH allows the UEs to receive HSDPA packets enabling a user equipment (UE) to receive large burst of downlink data. Similarly, after the 3GPP release 8 introduced HSUPA to Enhanced CELL_FACH, the UEs became equipped to send a large burst of uplink data. Thus, UEs that support Enhanced CELL_FACH are capable of transmitting large amount of data in the uplink and downlink while residing in the CELL_FACH state.

The HSDPA implementations include Adaptive Modulation and Coding (AMC), Hybrid Automatic Request (HARQ) retransmission protocol, and fast packet scheduling. A prevalent technique supporting HSDPA is adaptive modulation and coding (AMC), in which the modulation scheme and the coding rate are changed adaptively according to the downlink channel quality reported by the UE. Therefore, the channel quality indication (CQI) reporting scheme is directly related to the accuracy of AMC and the performance of HSDPA.

In 3GPP release 8, the transmission of HS-DPCCH that carries CQI is possible in CELL_FACH state in an opportunistic manner only when the UE has data to send on the E-DCH (Enhanced Dedicated Channel). It is recognized that this approach does not provide the NB with CQIs if there is no uplink transmissions prior to a HS-DSCH transmission. Hence in 3GPP release 11, improvements are proposed to remove the dependency of HS-DPCCH transmissions from uplink data transmission on E-DCH. In order to provide CQI prior to a HS-DSCH transmission, these CQI needs to be sent (e.g. via HS-DPCCH) consistently even when there is no traffic activity, for example, HS-DPCCH can be transmitted in a DTX (Discontinuous Transmission) manner. Document 2009/045840 A1 discloses a method and apparatus for signaling in a wireless transmit receive unit (WTRU). The method includes the WTRU receiving a value of a maximum number of retransmissions and retransmitting data in a plurality of hybrid automatic retransmission request (HARQ) processes limited by the value of a maximum number of retransmissions. The WTRU is configured to receive a cell-specific, fixed or absolute grant on a broadcast channel.

### SUMMARY

This summary is provided to introduce concepts related to sharing a enhanced uplink dedicated channel (E-DCH) resource from amongst a plurality of common E-DCH resources among multiple user equipments (UEs) on time multiplexing basis. This summary is not intended to identify essential features of the claimed subject matter nor is it intended for use in determining or limiting the scope of the claimed subject matter.

In an embodiment of the present subject matter, a method for sharing the E-DCH resource on time multiplex basis is described. The method includes receiving, from a UE, a random access procedure (RAP) request for allocation of the E-DCH resource from amongst a plurality of common E-DCH resources. The method further includes identifying the E-DCH resource to be time multiplexed between a plurality of UEs based on the RAP request. The method also includes allocating the identified E-DCH resource to the UEs on a time multiplex basis, wherein the E-DCH resource is shared among the plurality of UEs.

In another embodiment of the present subject matter, a UE configured to access an E-DCH resource that is time multiplexed among several UEs is described. The UE includes a UE uplink control module configured to send a random access procedure (RAP) request to a Node B (NB) for allocation of an E-DCH resource. The UE further includes a UE configuration module configured to receive a pattern associated with an allocated E-DCH resource, wherein the allocated E-DCH resource is time multiplexed among a plurality of UEs.

In accordance with another embodiment of the present subject matter, a computer readable medium having a set of computer readable instructions that, when executed, perform acts including identifying a plurality of UEs for sharing a E-DCH resource, wherein the sharing is on time multiplexing basis, determining a pattern of sharing associated with the E-DCH resource, wherein the pattern comprises one or more of a cycle of the E-DCH resource, a duration of the availability of the E-DCH resource during each cycle, and a offset where transmission in each cycle should start, and notifying the pattern of sharing to the plurality of UEs sharing the E-DCH resource.

### BRIEF DESCRIPTION OF THE FIGURES

The detailed description is described with reference to the accompanying figures. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 illustrates a wireless communication environment for data transfer in wireless communication networks, in accordance with an embodiment of the present subject matter.

FIG. 2 illustrates an enhanced uplink dedicated channel (E-DCH) resource sharing between multiple User Equipments (UEs) on time multiplexing basis, in accordance with an embodiment of the present subject matter.

FIG. 3 (a) illustrates a method of utilizing an E-DCH resource shared among several UEs on a time multiplex basis, in accordance with an embodiment of the present subject matter.

FIG. 3 (b) illustrates a method of utilizing an E-DCH resource shared among several UEs on a time multiplex basis, in accordance with another embodiment of the present subject matter.

FIG. 3 (c) illustrates a method of utilizing an E-DCH resource shared among several UEs on a time multiplex basis, in accordance with yet another embodiment of the present subject matter.

FIG. 4 illustrates a pattern in which a E-DCH resource is time multiplexed and shared among multiple UEs, in accordance with an embodiment of the present subject matter.

FIG. 5 (a) illustrates an exemplary method for allocation of a E-DCH resource to the UE, in accordance with an embodiment of the present subject matter.

FIG. 5 (b) illustrates an exemplary method for data transfer on a E-DCH resource shared among several UEs on a time multiplex basis, in accordance with another embodiment of the present subject matter.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

### DESCRIPTION OF EMBODIMENTS

Systems and methods for sharing uplink resources in Universal Mobile Telecommunications System (UMTS) are described. In one implementation, the resources of the Enhanced uplink Dedicated Channel (E-DCH) in the UMTS are shared among multiple user equipments (UEs). The methods can be implemented in systems capable of exchanging data in accordance with the Global System for Mobile (GSM) communication standards and support evolved High Speed Packet Access (HSPA) functionality. The evolved HSPA may include the enhanced high speed downlink packet access (HSDPA) and high speed uplink packet access (HSUPA) according to the 3GPP release 7 and release 8. Although the description herein is with reference to UMTS, the systems and methods may be implemented in other networks, albeit with a few variations, as will be understood by a person skilled in the art.

The techniques described herein may be used for various wireless communication systems such as Code Division Multiple Access (CDMA), Time Division Multiple Access (TDMA), Frequency Division Multiple Access (FDMA), Orthogonal Frequency-Division Multiple Access (OFDMA), Single Carrier Frequency Division Multiple Access (SC-FDMA) and other systems. A CDMA system may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.20, IEEE 802.16 (WiMAX), 802.11 (WiFi™), Flash-OFDM®, etc. UTRA and E-UTRA are part of Universal Mobile Telecommunication System (UMTS). 3GPP Long Term Evolution (LTE) is an upcoming release of UMTS that uses E-UTRA. UTRA, E-UTRA, UMTS, LTE and GSM are described in documents from an organization “3rd Generation Partnership Project” (3GPP). cdma2000 and UMB are described in documents from an organization named “3rd Generation Partnership Project 2” (3GPP2). For clarity, certain aspects of the techniques are described below for WCDMA, and 3GPP terminology is used in much of the description below.

The systems and methods can be implemented in a variety of entities, such as communication devices, and computing systems. The entities that can implement the described method(s) include, but are not limited to, desktop computers, hand-held devices, laptops or other portable computers, tablet computers, mobile phones, PDAs, smartphones, and the like. Further, the method may also be implemented by devices capable of exchanging data to provide connectivity to different communicating devices and computing systems. Such devices may include, but are not limited to, data cards, mobile adapters, wireless (WiFi™) adapters, routers, and the like. Although the description herein is explained with reference to a communicating device such as a smartphone, the described method(s) may also be implemented in any other devices, as will be understood by those skilled in the art.

The increasing use of telecommunication devices such as cell phones, laptops, Personal Digital Assistants (PDAs), and smart phones has increased the requirements of workforce mobility. Advancements in the telecommunication technology are constantly made to meet demands of the ever increasing number of the telecommunication devices. Wireless communication systems continue to evolve to meet user demands by efficiently utilizing the available limited resources.

To provide enhanced data transfer capabilities with increased throughput and better resource utilization, UMTS networks based on wideband code division multiple access (WCDMA) have been deployed worldwide as 3G mobile communications systems. According to the specifications of the UMTS, a UE with a Radio Resource Control (RRC) Connection can be in CELL_DCH, CELL_FACH, CELL_PCH or URA_PCH state. Different cell states are defined to handle different traffic and data exchange conditions for which separate operating conditions and resources are defined. CELL_PCH and URA_PCH states are idle or dormant states where for a UE with no/little traffic activity whilst a UE transmitting/receiving data traffic is put into the CELL_DCH or CELL_FACH state. In the CELL_DCH and CELL_FACH state, the UE is able to transmit and receive user data. The CELL_FACH state is usually used for UEs with low burst traffic activity.

In the 3GPP release 7, an enhanced CELL_FACH feature has been introduced in UMTS which allows a UE to receive HSDPA packets while the UE is in CELL_FACH state. This enables the UE to receive large burst of downlink data. In the 3GPP release 8, HSUPA was introduced to the enhanced CELL_FACH feature, enabling the UE to send a large burst of uplink data in the CELL_FACH state. The bursty nature of smartphone traffic is suited for the Enhanced CELL_FACH as compared to that in CELL_DCH state since bursty traffic is carried more efficiently using Enhanced CELL_FACH than that in the CELL_DCH state.

The improvements in UMTS and the new releases such as release 11 by 3GPP provide an enhancement to the Enhanced CELL_FACH technique. Since one of the technique supporting HSDPA is adaptive modulation and coding (AMC), in which the modulation scheme and the coding rate used by the base transceiver station (BTS) or Node B (NB) are changed adaptively according to the downlink channel quality reported by the UE, the accuracy of AMC and the performance of HSDPA is highly dependent on the channel quality indication (CQI) reported by the UE.

While the UE is in CELL_FACH state, the CQI is reported to the NB, through a High Speed Dedicated Physical Control Channel (HS-DPCCH). Further, apart from the CQI, the HS-DPCCH may also carry acknowledgements provided by the UE in response to the HSDPA packets received, from the NB. Prior to Enhanced CELL_FACH being introduce to UMTS, a cell was in CELL_FACH state. The use of HS-DPCCH by utilizing the Enhanced CELL_FACH to report the CQI was limited by the UE depending upon the requirement of the UE to send data over the Enhanced uplink Dedicated Channel (E-DCH). However, since the accuracy of AMC is dependent on the CQI reporting, the 3GPP release 11 proposes the transmission of CQI on the HS-DPCCH without any dependency of transmission from uplink data transmission on E-DCH. Therefore, to improve the reporting of channel quality while the UE is in CELL_FACH state, the latest 3GPP release, release 11, proposes that the CQI for the downlink channel to be provided by the UE consistently irrespective of the traffic activity handled by the UE.

Since, when the UE is in CELL_FACH state, the transmission of CQI in the uplink, through the HS-DPCCH requires uplink resources, and the availability and allocation of uplink resources for such transmission becomes a necessity. According to the specification of UMTS, the uplink resources available in the CELL_FACH state of the RRC connection are common resources and are not dedicated as are in the CELL_DCH state. However, as the capability of HSPA including the HSDPA and the HSUPA is implemented in the Enhanced CELL_FACH feature, the reporting of the CQI has to be done through the limited and common uplink resources present in the CELL_FACH state.

Each BTS or NB has limited number of uplink channel resources which are shared among the UEs residing in CELL_FACH state. These common uplink channel resources may include the Random Access Channel (RACH) or the Enhanced uplink Dedicated Channels (E-DCH). Any of such uplink channel resources when allocated to one UE, cannot be allocated to another UE. Therefore in situations when majority of the common channels such as the common E-DCH resources are allocated to different UEs, the available uplink channel resources become scarce and needs to be contested for. Hence, the repeated transmission of the CQI information through the common and limited uplink channel resources consumes significant resources for multiple instances. Further, the E-DCH or RACH resource allocation for mere transmission of CQI information also results in inefficient usage of the uplink channels as the channel capable of transmitting bulky data is reserved for mere CQI transmission. Also, since the number of smartphone devices is increasing significantly, more and more UEs are residing in the CELL_FACH state utilizing the Enhanced CELL_FACH feature and hence, the need to transmit the CQIs by all these devices leads to congestion, failure in resource allocations, and exhaustion of the channel resources.

Typically, to access any of the uplink resources such as the RACH or the E-DCH, a UE performs a random access procedure. The random access procedure is completed in two stages. The first stage is referred to as the preamble stage where a preamble specifying the requested resource, such as the RACH and the E-DCH is transmitted whereas the second stage is the data transmission stage where the actual message is transmitted. Since before the transmission of the actual message, the resource requested by the UE has to be allocated by the NB, therefore, the UE has to wait for a confirmation from the NB before transmission of the actual message. Further, once the confirmation of allocation of resource is received, the UE and the NB perform a handshake or synchronization. During the synchronization, the quality of the transmission based on pre-defined parameters such as Signal-to-Noise Ratio (SNR) is determined The process of handshake may take several milliseconds and therefore, performing the synchronization every time when mere CQI information is to be send does not optimally utilize the available resources. Further, in situations where the synchronization procedure fails, the data transmission is not allowed and the UE has to start the complete random access procedure again to acquire uplink resource and perform the transmission. The possibility of such an event may add to an extra delay in transmission of data when the synchronization is not completed successfully.

Hence, if the recursive and consistent CQI transmission is done in CELL_FACH state, before every transmission, the UE would perform the random access procedure involving preamble transmission, channel acquisition and synchronization. Since generally, the E-DCH resources are used for transmission of bulky data and infrequent, the time required to complete the channel acquisition and the synchronization is acceptable, however, the procedure of channel acquisition and synchronization for mere transmission of CQI, which is a small burst of data and consistent, would consume more time in the initial stage than in the actual information transmission stage.

According to an implementation of the present subject matter, systems and methods for sharing the uplink resources on a time multiplexing basis are described. In one embodiment, the uplink E-DCH resources available in the CELL_FACH state are shared for the transmission of consistent and recursive CQI. The systems and methods can be implemented in a variety of processing and communicating devices. The devices that can implement the described methods and systems include, but are not limited to, desktop computers, hand-held devices, laptops or other portable computers such as tablet computers, mobile phones, PDAs, smartphones, and the like. Further, the devices capable of exchanging data to provide network connectivity or capability to exchange data in different communicating devices and computing systems may also implement the described methods and systems. Such devices may include, but are not limited to, data cards, mobile adapters, WiFi™ adapters, routers, and the like. Although the description herein is explained with reference to a communicating device such as a smartphone, the described method(s) may also be implemented in any other devices, as will be understood by those skilled in the art.

The systems and methods as described herein, on one hand, enable sharing of uplink resources to transmit CQI, on the other, allow transmission of actual data through the shared uplink resources. The common resources available to a UE residing in the CELL_FACH state may either be the RACH or the EDCH resources. In general, the total number of these resources is allocated among the UEs based on their availability as the allocation is subjected to a UE releasing the acquired resource and another UE contenting for it. For example, a NB may have 32 available E-DCH resources which it can share among the UEs served. In case each of the available 32 E-DCH resources is allocated to 32 different UEs, the NB has no more E-DCH resource left to allocate to a 33^{rd} UE. In such a scenario, the allocation of an E-DCH resource to the 33^{rd} UE is subjected to the release of any one of the already acquired E-DCH resource by one for the 32 UEs.

Since the uplink resources, such as the E-DCH are limited in number and it is not efficient to seize these resources for the frequent CQI transmission through the HS-DPCCH, in one implementation of the present subject matter, the uplink E-DCH resources are divided into two different sets of uplink resources. In said implementation, a first set of resources may be dedicated for bulky data transfer and can be allocated in a conventionally known manner and therefore, details of such allocation have not been elaborated here for the sake of brevity. Also, for the sake of clarity, such resources are referred to as legacy E-DCH resources. The second set of E-DCH resources may constitute the E-DCHs which can be shared among the multiple UEs on a time multiplex basis. The second set of E-DCH resources may be allocated to the UEs based on time multiplexing and the UEs sharing these resources need not release the resource for other UEs, rather use the resource at fixed time instances. Accordingly, the UEs may also not need to contest for such E-DCH resource every time it wishes to transmit small amount of data, such as CQI through the uplink resource. The second set of time multiplexed E-DCH resources are also referred to as E-DCH resources hereinafter. However, the first set of E-DCH resources are referred to as legacy E-DCH resources hereinafter.

According to an implementation of the present subject matter, the second set of common E-DCH resources is time multiplexed to be shared among multiple UEs. As described before, to acquire an E-DCH resource, an UE has to first go through the channel acquisition and then perform synchronization with the NB to send out the actual data. Therefore, to reduce the redundant and the time consuming step of channel acquisition and synchronization for consistent CQI transmission, in one implementation, the process of channel acquisition and synchronization may be done only once when the UE requests for the E-DCH resource for the first time. In said implementation, the NB, after completion of the synchronization, may assign an E-DCH resource from the second set of common E-DCH resources which is time multiplexed and shared among several UEs. As would be understood by those skilled in the art that since the E-DCH resource is time shared, the entire channel resource would be available to a single UE but, only for a limited time period. In one implementation, the limited time period may be decided by the NB and may be a multiple of Transmission Time Interval (TTI). It would also be understood by those skilled in the art that the time for which the E-DCH resource is allocated to each UE may be different and multiple UEs may have multiple distinct allocated time periods.

According to an implementation of the present subject matter, for the time period when the E-DCH resource is available with an UE, the UE may transmit the CQI in the HS-DPCCH. Since the CQI information is short and requires a small burst, the common E-DCH resources can be time multiplexed and shared among several UEs. In another implementation, prior to the transmission of the CQI in the HS-DPCCH, the UE may send few bursts of Uplink (UL) Dedicated Physical Control Channel (DPCCH) to enable the NB to indicate to the UE of the required transmit power. As would be known to a person skilled in the art, a NB determines the quality of the DPCCH and transmits Transmit Power Control (TPC) commands to the UE via the Fractional Dedicated Physical Channel (F-DPCH). Hence, the transmission of few bursts of DPCCH before the actual HS-DPCCH allows the UE to respond to the NB at a required power level. Further, the transmission of few bursts of DPCCH before the actual HS-DPCCH also allows the NB to have a few channels estimation averages which may help in the demodulation of the data coming through the E-DCH resource.

In one implementation, the NB allocates the time multiplex E-DCH resource to the UE based on layer 1 or MAC signaling. The functionality of the layer 1 and that of the MAC signaling have been laid by the UMTS specification and the details are therefore not included for the sake of brevity. In an example, the time multiplexed E-DCH resource is allocated using the High Speed Shared Control Channel (HS-SCCH) order and contains the pattern of the time multiplexed E-DCH resource. The pattern of the time multiplex resource allocation may represent and indicate to a UE, the cycle of the E-DCH resource, the duration of the availability of the E-DCH resource during each cycle, and the offset where the transmission in each cycle should start. Therefore, the pattern of resource allocation provides a clear picture of the availability of the resource to the UE. Also, since the details of the allowed transmission interval, the duration of transmission, etc., are available with the UE, the UE is not required to request for a new common uplink resource before every CQI transmission. Further, the process of synchronization which may require several milliseconds, is also not required during every transmission of the CQI information.

In one embodiment of the present subject matter, the UE that is assigned a time multiplexed E-DCH resource can still request for a legacy E-DCH from the first set of E-DCH resources. As would be understood by those skilled in the art that the UE may require to send some bursty data through the uplink to the NB. In the CELL_FACH state, the only available resources for such a transmission are the common E-DCH resources. Since the nature of data to be transmitted is bursty, the UE may request for an E-DCH resource from the first set of E-DCH resources apart from the shared E-DCH resource allocated to the UE for CQI transmission. This may provide uncompromised quality of service when the UE has another traffic type that is best served using the legacy E-DCH resource which is not time multiplexed and available to the UE when allocated by the NB.

In said embodiment, according to one implementation, the UE can temporarily pause its time multiplex transmission of the CQI through the HS-DPCCH until the transmission on the legacy common E-DCH is compete. However, in another implementation, the UE may simultaneously transmit data over the time multiplex resource and the legacy common E-DCH resource. Although it has been described that a UE may transmit over shared and legacy E-DCH resources either serially or in parallel, it would to be understood that to acquire a legacy E-DCH resource, the UE may still have to go through the channel acquisition and the synchronization phase.

Further, according to an embodiment of the present subject matter, a different set of common channels for the HS-DPCCH transmission may be utilized other than the E-DCH without digressing from the intent and scope of the described technique. The different set of common channels may be time multiplexed and shared across the different UEs based on the techniques described above to utilize the presently used resources such as E-DCH for their intended purposes.

The above methods and system are further described in conjunction with the following figures. It should be noted that the description and figures merely illustrate the principles of the present subject matter. It will thus be appreciated that those skilled in the art will be able to devise various arrangements that, although not explicitly described or shown herein, embody the principles of the present subject matter and are included within its spirit and scope. Furthermore, all examples recited herein are principally intended expressly to be only for pedagogical purposes to aid the reader in understanding the principles of the present subject matter and the concepts contributed by the inventor(s) to furthering the art, and are to be construed as being without limitation to such specifically recited examples and conditions. Moreover, all statements herein reciting principles, aspects, and embodiments of the present subject matter, as well as specific examples thereof, are intended to encompass equivalents thereof.

It will also be appreciated by those skilled in the art that the words during, while, and when as used herein are not exact terms that mean an action takes place instantly upon an initiating action but that there may be some small but reasonable delay, such as a propagation delay, between the initial action and the reaction that is initiated by the initial action. Additionally, the word “connected” is used throughout for clarity of the description and can include either a direct connection or an indirect connection.

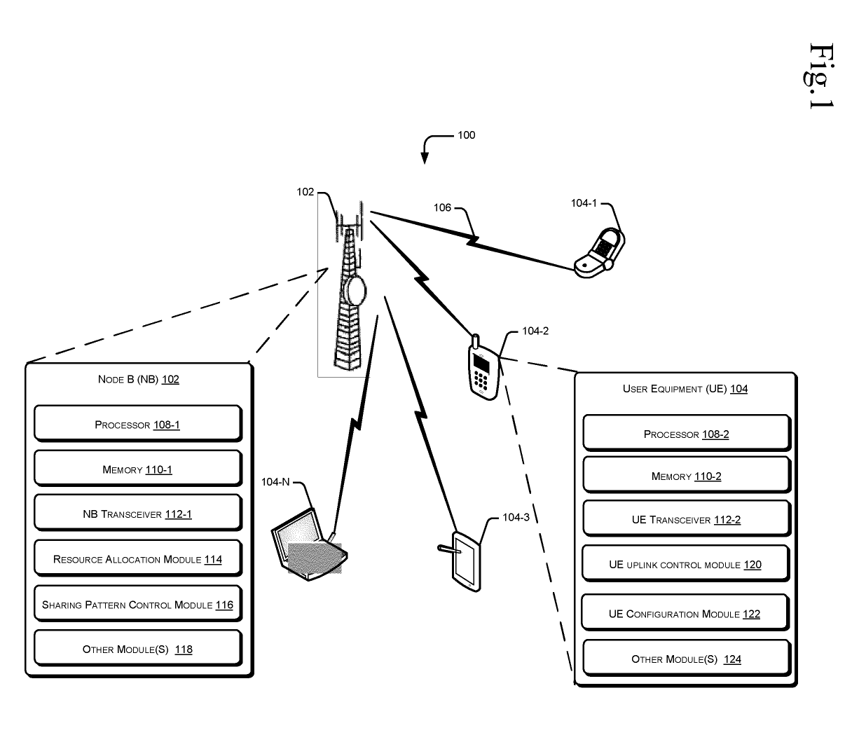

The manner in which the systems and methods for sharing uplink resource in a UMTS is implemented shall be explained in details with respect to the FIGS. 1-5. While aspects of described systems and methods for sharing uplink resources can be implemented in any number of different computing systems, environments, and/or configurations, the embodiments are described in the context of the following exemplary system(s).

FIG. 1 illustrates a wireless communication environment 100 for data transfer in wireless communication networks, in accordance with an embodiment of the present subject matter. In one implementation, the environment 100 includes a Node B (NB) 102 and multiple UEs 104-1, 104-2, 104-3, 104-3, and 104-N. For the sake of clarity, the multiple UEs 104-1, 104-2, 104-3, . . . ,104-N are collectively referred to as UEs 104 and individually as UE 104, hereinafter. The NB 102 may control and communicate with the UEs 104 via radio channels, such as the radio link 106 having an uplink and a downlink.

The NB 102 may be a fixed station that communicates with the UEs 104 and may also be referred to as an evolved Node B (eNB), a base station, an access point, etc. NB 102 provides communication coverage for a particular geographic area. The coverage area of NB 102 may be partitioned into multiple smaller areas. Each smaller area may be served by a respective NB subsystem. In 3GPP, the term “cell” can refer to the smallest coverage area of a NB 102 and/or a NB subsystem serving this coverage area.

The UEs 104 may include, but are not limited to, desktop computers, hand-held devices, laptops or other portable computers, tablet computers, mobile phones, PDAs, smartphones, and the like. Further, the UEs 104 may include devices capable of exchanging data to provide connectivity to different communicating devices and computing systems. Such devices may include, but are not limited to, data cards, mobile adapters, wireless (WiFi™) adapters, routers, a wireless modem, a wireless communication device, a cordless phone, a wireless local loop (WLL) station, and the like. As UEs 104 may be stationary or mobile and may also be referred to as a mobile station, a terminal, an access terminal, a subscriber unit, a station, etc.

It would be understood by those skilled in the art that the NB 102 may be connected to a Radio Network Controller (RNC) (not shown) where the RNC is configured to control the NB 102 by managing resources of the communication network and coordinate data transfer through the NB 102. Further, the RNC may be implemented as a network server, a server, a workstation, a mainframe computer, and the like.

In said implementation, the NB 102 includes a processor 108-1, and the UE 104 includes a processor 108-2. The processors 108-1 and 108-2 are collectively referred to as the processors 108 hereinafter.

The processor(s) 108 may include microprocessors, microcomputers, microcontrollers, digital signal processors, central processing units, state machines, logic circuitries and/or any other devices that manipulate signals and data based on operational instructions. The processor(s) 108 can be a single processing unit or a number of units, all of which could also include multiple computing units. Among other capabilities, the processor(s) 108 are configured to fetch and execute computer-readable instructions stored in one or more computer readable mediums.

Functions of the various elements shown in the figure, including any functional blocks labeled as “processor(s)”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included.

The computer readable medium may include any computer-readable medium known in the art including, for example, volatile memory, such as random access memory (RAM) and/or non-volatile memory, such as flash.

The NB 102 and UEs 104 further include memory 110-1 and 110-2 respectively. The memory 110-1 and 110-2 are collectively referred to as memories 110 hereinafter. The memories 110 may include any computer-readable medium known in the art including, for example, volatile memory such as static random access memory (SRAM) and dynamic random access memory (DRAM), and/or non-volatile memory, such as read only memory (ROM), erasable programmable ROM, flash memories, hard disks, optical disks, and magnetic tapes.

In one implementation, the NB 102 and the UEs 104 also include a transceiver, such as the NB transceiver 112-1 and the UE transceiver 112-2. The NB 102 includes, amongst other things, various modules such as the resource allocation module 114, a sharing pattern control module 116, and other modules 118. In said implementation, the UE 104 includes amongst other things modules such as UE uplink control module 120, a UE configuration module 122, and other modules 124.

The various modules described herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. Further the functionalities of various modules may be embodied directly in hardware, in a software module executed by a processor, or in a combination of the two.

In operation, the NB transceiver 112-1 is configured to transmit and receive data between the UEs 104 over the downlink and the uplink through the radio link 106. Similarly, the UE transceiver 112-2 is configured to transmit and receive data with the NB 102 over the uplink and the downlink through the radio link 106. During the communication and a RRC connection between the UE 104 and the NB 102, the UE 104 may reside in any of the CELL_DCH, CELL_FACH, CELL_PCH or URA_PCH state. In the CELL_FACH and the CELL_DCH state, the UE 104 may exchange data and handle traffic over the uplink and the downlink with the NB 102. The UE 104 may implement the Enhanced CELL_FACH feature of the CELL_FACH state. The UE configuration module 122 may be configured with the functionality of the HSDPA and the HSUPA. The UE 104 implementing the Enhanced CELL_FACH feature, supports the adaptive modulation and coding (AMC) technique to allow the NB 102 to change the modulation scheme and the coding rate adaptively according to the downlink channel quality reported by the UE 104.

Although described earlier, for the sake of clarity it is described that the UE 104 may report the channel quality to the NB 102 by transmitting a Channel Quality Indicator (CQI). The CQI is a measurement of the communication quality of radio link 106. The CQI may represent a value or a set of values representing a measure of channel quality for a given channel. Typically, a high value CQI is indicative of a channel with high quality and vice versa. A CQI for a channel can be computed by the UE 104 by considering a performance metric, such as a signal-to-noise ratio (SNR), signal-to-interference plus noise ratio (SINR), and signal-to-noise plus distortion ratio (SNDR)of the channel It would be understood by those skilled in the art that the CQI for a given channel may be dependent upon the transmission or the modulation scheme used by the NB 102 and the UE 104. For example, a communication system using code-division multiple access (CDMA) may make use of a different CQI than a communication system that makes use of orthogonal frequency division multiplexing (OFDM). However, the transmission of CQI enables the NB 102 to adapt the coding and modulation scheme irrespective of the dependency of the CQI on different communication systems and hence, the transmission of CQI is important for the proper implementation of the HSDPA, irrespective of the transmission or modulation scheme utilized to compute the CQI.

To transmit the CQI, the UE uplink control module 120 may perform a random access procedure. As described before, during a random access procedure, the UE 104 may transmit a preamble indicating a choice of resource among E-DCH and RACH. Since the CQI information is transmitted over High Speed Dedicated Physical Control Channel (HS-DPCCH), the UE uplink control module 120 may transmit a preamble corresponding to the request of E-DCH channel. It would be understood that for request of different channels, different preambles are known, both to the UE 104 and the NB 102. Therefore, according to an implementation of the present subject matter, for requesting allocation of an E-DCH resource, the preamble corresponding to the E-DCH channel is transmitted by the UE uplink control module 120.

Based on the received preamble from the UE 104, the NB identifies the resource for which the UE 104 has requested for. In said implementation, since the UE uplink control module 120 has transmitted a preamble to request for an E-DCH resource, the resource allocation module 114 of the NB 102 identifies the preamble and checks for the available E-DCH resources. Since the preamble is known to both, the UE 104 and the NB 102 to differentiate between the requested resources, in one implementation, separate preamble may be defined that can be shared between the NB 102 and the UE 104 to identify the UE's 104 request of an E-DCH resource for CQI transmissions. The presence of such a preamble may allow the resource allocation module 114 of the NB 102 to allocate the resources on time multiplex basis and would help in efficient utilization of resources.

In said implementation, since the UE 104 has requested for an E-DCH resource, the resource allocation module 114, after completing the preamble identification, may allocate an E-DCH to the UE 104 from the second set of common E-DCH resources that is time multiplexed among several UEs 104. For example, among the 32 E-DCH resources available with the NB 102, the resource allocation module 114 may reserve 1 resource for the second set of E-DCH resources and use all the remaining 31 E-DCH resources for allocation in a conventional manner, hereinafter referred to as legacy allocation. The 1 E-DCH resource may be used for CQI transmission of the UEs 104 and is time multiplexed between the UEs 104 supported by the NB 102.

In another implementation, the NB 102 may reserve 4 E-DCH resources for the purpose of time multiplexing and may share these resources between several UEs 104 while keeping the remaining 28 E-DCH resources for legacy allocations. In said implementation, where more than one E-DCH resource is reserved by the resource allocation module 114 for time multiplexing, each E-DCH resource among the reserved resources may be shared among a particular number of UEs 104. For example, if 2 E-DCH resources are reserved by the resource allocation module 114 for time multiplexing and the E-DCH resources are to be shared among 8 UEs, the resource allocation module 114 may time multiplex the first E-DCH resource between UE 1, UE 5, UE 7 and UE 8. Further, the second E-DCH resource may be time multiplexed among the remaining UEs such as the UE 2, UE 3, UE 4, and UE 6. Further, it would also be understood that the time multiplex resource allocated by the resource allocation module 114 to the UE 104 for the transmission of CQI may be utilized by the UE 104 for transmission of data packets instead of transmission of CQI.

In another implementation, the UE 104 and the NB 102 may not share a different and distinct preamble for requesting the allocation of a E-DCH resource from amongst several common E-DCH resources for the purpose of CQI transmission. Instead, the resource allocation module 114 may, by default, provide the UE 104 with a shared E-DCH resource that is time multiplexed among several UEs 104. The resource allocation module 114 may be configured to provide a resource from the second set of E-DCH resources that are time multiplexed on the first request of resource allocation from the UE 104. In said implementation also, it will be appreciated that the UE 104 may utilize the allocated resource for CQI transmissions as well as for the transmission of data packets.

As described earlier, the E-DCH resource reserved by the resource allocation module 114 may be shared among several UEs 104 on time multiplexing basis. In one implementation, for the time multiplexed E-DCH resource allocated by the resource allocation module 114 to the UE 104, the sharing pattern control module 116 may also determine a pattern in which the E-DCH resource would be shared among the UEs 104 and would be accessible to each UE 104. The pattern of the time multiplexed E-DCH resource allocation may represent and indicate to the UE 104, a cycle of the E-DCH resource, the duration of the availability of the E-DCH resource during each cycle, and the offset where the transmission in each cycle should start. In other words, the sharing pattern control module 116 notifies to the UE 104 the slots that are available for uplink transmissions, thereby providing a clear picture of the availability of the resource to the UE 104. The pattern determined by the sharing pattern control module 116, in said implementation, may be notified to the UE 104 through the NB transceiver 112-1.

Once the resource allocation module 114 has allocated a time multiplexed E-DCH resource to the UE 104 and the sharing pattern control module 116 has notified to the UE 104 the pattern of sharing the allocated E-DCH resource, the UE 104 may transmit the data over the E-DCH resource at the allocated time instance without performing the random access procedure before every transmission. Since the NB 102 is aware of the time instances and the pattern at which different UEs 104 would transmit data through the time multiplexed E-DCH resource, the NB 102 also does not need a preamble from the UE 104 before every transmission. Hence, time multiplexing a E-DCH resource among several UEs 104 reduces the requirement of performing the channel acquisition and synchronization for consistent CQI transmissions thereby saving resource acquisition time.

It would be understood by those skilled in the art that the time period for which the E-DCH resource is allocated to each UE 104 may be different and multiple UEs 104 may have multiple distinct allocated time periods. The time period may be a multiple of TTI as would be understood by a person skilled in the art. Also, since the details of the allowed transmission interval, the duration of transmission, etc., are available with the UE 104, the UE 104 is not required to request for a common uplink resource before every CQI transmission. Further, since the time duration of the availability, cycle of the E-DCH resource after which a UE 104 can transmit data is different for different UEs 104, it would be understood that the pattern of sharing the resource for one UE 104 may be different from the pattern of another UE 104.

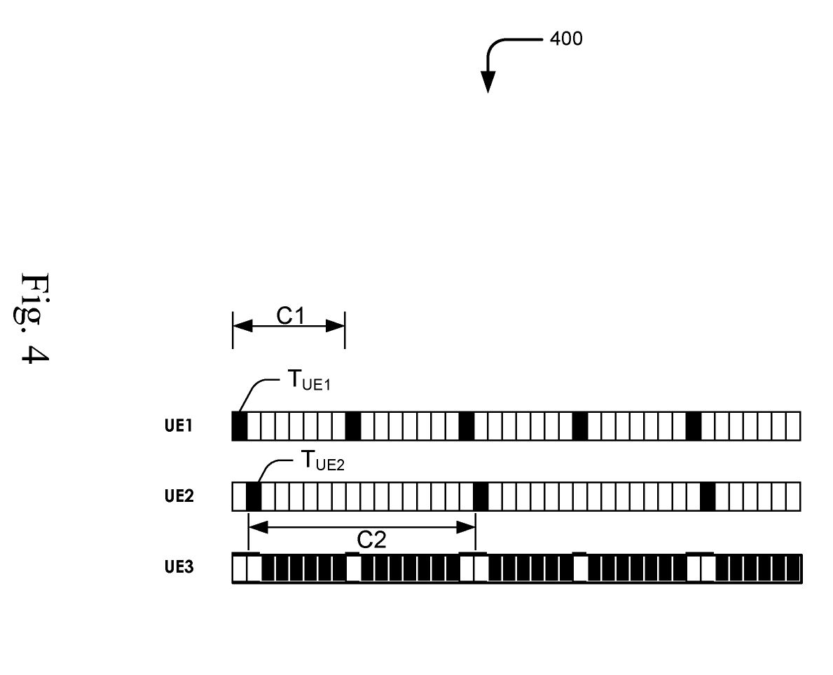

In one implementation of the present subject matter, the sharing pattern control module 116 uses the HS-SCCH order to determine the pattern of each E-DCH resource that is shared and time multiplexed amongst several UEs 104. The details of a pattern in which an E-DCH resource can be multiplexed by the sharing pattern control module 116 is described in detail with reference to FIG. 4.

According to an implementation of the present subject matter, the UE configuration module 122 is configured to transmit the CQI information in the HS-DPCCH based on the pattern notified by the sharing pattern control module 116. In said implementation, prior to the transmission of the CQI in the HS-DPCCH, the UE 104 may send few bursts of uplink DPCCH to enable the NB 102 to indicate to the UE 104 of the required transmit power. As would be known to a person skilled in the art that the NB 102 would judges the quality of the DPCCH and transmit a Transmit Power Control (TPC) command to the UE 104 via the Fractional Dedicated Physical Channel (F-DPCH). Hence, the transmission of few bursts of DPCCH before the actual HS-DPCCH allows the UE 104 to respond to the NB 102 at a required power level. Further, the transmission of few bursts of DPCCH before the actual HS-DPCCH also allows the NB 102 to have a few channels estimation averages which may help in the demodulation of the data coming through the E-DCH resource.

Although it has been described that through the E-DCH resource that is time multiplexed between UEs 104, the UE 104 can also transmit data instead of CQI information, however, in one embodiment of the present subject matter, the UE uplink control module 120 is also configured to request for a non time multiplexed E-DCH resource, such as the legacy E-DCH resource which would be allocated based on the legacy procedure. In one implementation of the said embodiment, the legacy E-DCH resource can be used for transmission of user traffic data and the UE 104 may request for such resources in spite of an allocated time multiplexed common E-DCH resource. The UE 104 may request for a legacy E-DCH resource in situations when the data to be transmitted through the uplink to the NB 102 is bursty in nature and requires a dedicated uplink resource. Based on the request of UE uplink control module 120 to allocate a legacy E-DCH resource, the resource allocation module 114 of the NB 102 may allocate an E-DCH resource from the first set of E-DCH resources to the UE 104.

As described earlier, the request for allocation of a resource is made by the UE uplink control module 120. According to the embodiment described above, to request for a legacy E-DCH resource, the UE uplink control module 120 would perform the random access procedure. During the random access procedure, the UE 104 and the NB 102 may go through the preamble stage and the channel acquisition stage before the actual transmission of data. Once the UE 104 is allocated one of the legacy E-DCH resources, the E-DCH resources, the UE uplink control module 120 may control the uplink transmission. In one implementation, the UE uplink control module 120 may pause the transmission of data over time multiplexed E-DCH resource while transmitting bursty data over the legacy E-DCH resource. However, in another implementation, the UE uplink control module 120 may transmit through both the legacy and the time multiplexed channel in parallel.

In another embodiment, the CQI information may be sent through the HS-DPCCH without constantly transmitting data in the E-DCH. As would be known to those skilled in the art, the transmission of data in E-DCH includes Enhanced Uplink Dedicated Channel Radio Network Temporary Identifier (E-RNTI) which specifies the Identification (Id.) of the UE 104. Generally, the transmission of E-RNTI in the E-DCH is terminated by a UE 104 when an E-DCH Absolute Grant Channel (E-AGCH) is received by the UE 104 with the Id. of the UE 104 in the E-AGCH. Therefore, in an implementation of the said embodiment, the UE uplink control module 120 of the UE 104 terminates the transmission of data in the E-DCH once E-AGCH is received from the NB 102. NB 102 identifies E-DCH and adjoining HS-DPCCH transmission based on E-RNTI contained in the E-DCH message and thus, uniquely identifying the UE 104. It notifies the UE 104 of this successful identification through E-AGCH which includes the same E-RNTI. After this handshake mechanism, the UE 104 can terminate E-DCH transmission and only transmit HS-DPCCH. Since NB 102 has successfully identified the UE 104, the NB 102 can continue receiving HS-DPCCH from that UE 104 based on known transmission cycle, burst and transmission offset without constantly receiving information in the E-DCH. In other words, after the UE 104 receives E-AGCH, the transmission of data in E-DCH can be avoided to save wastage of resources.

Yet in another embodiment of the present subject matter, to make efficient use of the resources, the transmission in the HS-DPCCH may also include the High Speed downlink Shared Channel Radio Network Temporary Identifier (HS-DSCH-RNTI or H-RNTI) which corresponds to the HSDPA operation. As described before, the HS-DPCCH, apart from the CQI, may also include the Hybrid Automatic Repeat Request (HARQ) acknowledgements that are sent for the downlink packet received through High Speed Downlink Shared Channel (HS-DSCH). Since the data transmitted in the HS-DPCCH sent prior to any HS-DSCH need not contain a HARQ acknowledgement, the HARQ acknowledgements which occupy 10 bits in the HS-DPCCH sent prior to the HS-DSCH can be omitted to prevent wastage of the resource. Instead, the transmission in the HS-DPCCH can include the 16 bits of H-RNTI and the remainder bits left out of the total 30 bits can be used to transmit the CQI information.

In implementation, a different coding for the CQI, other than what is known in the art may be used. For example, the UE uplink module 120 of the UE 104 may use a (10,5) coding rather than the (20,10) where the new CQI is now only a linear combination of 5 linear basis sequences rather than 10 basis sequences to leave more bits for the transmission of the H-RNTI in the HS-DPCCH.

As discussed previously, during the transmission of CQI information through the HS-DPCCH, the UE 104 may also transmit data in E-DCH. An E-DCH transport channel consists of an E-DCH Dedicated Physical Control Channel (E-DPCCH) and at least one E-DCH Dedicated Physical Data Channel (E-DPDCH). The transmissions in E-DPCCH contain information on the format for the E-DPDCH for decoding purpose. Since the purpose of the E-DCH is to carry the UE Id. such as the E-RNTI and/or H-RNTI, in one embodiment of the present subject matter, the UE uplink control module 120 transmits data in a fixed format for the E-DPDCH thereby removing the requirement for the E-DPCCH and reducing the load in the uplink transmissions.

In one embodiment of the present subject matter, the UE uplink control module 120 transmits a reduced HARQ transmission while transmitting no data in the time multiplex E-DCH resource apart from the HS-DPCCH. In situation when there is no user data in the E-DCH and the E-DCH contains only the E-RNTI and/or H-RNTI, the time multiplex E-DCH is used to only piggy back the HS-DPCCH and the HARQ retransmission is not required. In case radio channel conditions between the UE 104 and the NB 102 are good it is assumed that the NB 102 would always receive information contained in E-DCH, i.e., E-RNTI, correctly in the first HARQ transmission. Therefore, for this transmission, acknowledgement from the NB 102 is not required and the UE 104 assumes that NB 102 has successfully received the E-RNTI information after the first transmission. In other words, the retransmission of the HARQ is not required and the number of HARQ transmissions can be reduced to 1. Since the HARQ transmissions are reduced, in the extreme cases, an acknowledgement from NB 102 is required, such as ‘no HARQ transmission’. Therefore, the reduction in the HARQ transmissions in situations of consistent HS-DPCCH transmission reduces the downlink resources that would have been used for transmitting acknowledgement in the downlink.

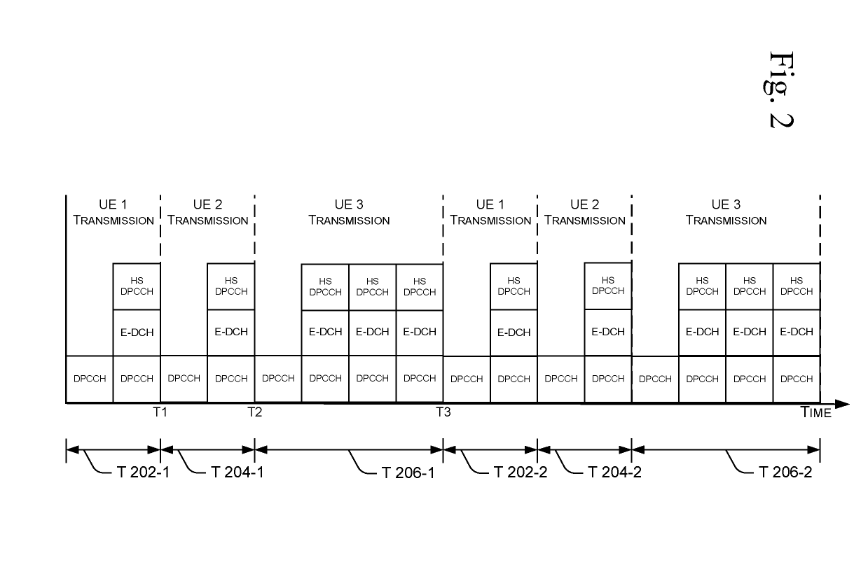

FIG. 2 illustrates an E-DCH resource being shared between three UEs 104, for example UE 104-1, 104-2 and 104-3, on time multiplexing basis. The E-DCH resource is depicted to be shared for the purpose of HS-DPCCH transmissions. The three UEs 104-1, 104-2 and 104-3 have been depicted by UE 1, UE 2, and UE 3. Further, the time period for which each UE 104 utilizes the resource is depicted in the figure. As seen in the figure, the E-DCH resource shared among three UEs 104 is shared serially by the UEs 104 where UE 1 transmits initially, followed by the UE 2 and then followed by the UE 3. Once the transmission of UE 3 is complete, UE 1 transmits again and the cycle followed initially is followed again where UE 2 transmits next, followed by the transmission of UE 3. It is depicted in the figure that the initial transmission of UE 1 is allotted T 202-1 time units. Similarly, the transmission of UE 2 is allotted T 204-1 time units and that of UE 3 is allotted T 206-1 time units. As is evident from the figure, the time duration T 202-1 and T 204-1 are equal while T 206-1 is double the time duration T 202-1 and T204-1. The different time durations depict the amount of time allocated to each UE by the NB 102.

As described before, the time duration of allocation of the resource may be a multiple of the TTI and therefore, the time T 202-1, T204-1, and T 206-1 may be of several TTIs. In one implementation, the time T 202-1 and T204-1 are equal to 2×TTI whereas the time T 206-1 is equal to 4×TTI. The transmission of UE 1 which ends at time T1 includes one initial DPCCH transmission to enable the NB 102 to indicate to the UE 1 of the required transmit power level. The details of the DPCCH transmission prior to the transmission of data have already been explained before and therefore, the details have been omitted here for the sake of brevity.

As shown in the figure, upon transmitting DPCCH, the UE 1 transmits the E-DCH followed by the HS-DPCCH. The CQI information is transmitted in the transmission of the HS-DPCCH transmitted by the UE 1. The transmission of UE 1 terminates at time T1 and the UE 2 starts its transmission. Similar to the transmission of UE 1, the UE 2 also transmits DPCCH followed by E-DCH and HS-DPCCH. The transmission of UE 3 starts after the transmission of UE 2 which starts at time T2. It would be appreciated that the time period for which the UE 3 transmits is double the time period of UE 1 and UE 2. Therefore, it would be understood that different UEs 104 may be allotted different time periods for transmission over the shared E-DCH resource. Similar to UE 1 and UE 2, the UE 3 also transmits DPCCH prior to the transmission of actual data and is depicted in the figure. Although it has been shown that each UE transmits DPCCH for one time period before the transmission of data, it would be appreciated that DPCCH transmission may also be of several time periods prior to the actual data transmissions by the UE 104.

Once the first transmission of all the three UEs is complete, the UE 1 would again start the transmission and transmit for the time period T 202-2. Since the transmission of data over the shared resource is done in a cyclic manner, the time period T 202-2 is same as the time period 202-1 Similarly the time period 204-2 for which UE 2 transmits for the second time, is same as the time period 204-1 and the time period 206-2 is same as the time period 206-1. It would be understood from the description of FIG. 2 that the shared E-DCH resource may be allocated on time multiplex basis to multiple UEs 104 and the time period for which each UE 104 may transmit the data may vary from one UE 104 to another.

Further, in said implementation, the time allotted to each UE 104 may not necessarily be utilized for the transmission of CQI information and rather, the UEs 104 may also transmit data other than the CQI. In another implementation of the described embodiment, the UE 1 may not transmit the CQI information at all in the time allotted to it for utilizing the time multiplexed E-DCH resource and instead, the UE 1 may utilize the time period for transmitting traffic other than CQI. Also, the UE 2 may utilize the time multiplex E-DCH resource for the purpose of CQI transmission on alternate cycles, i.e., for the first allotted time period, the UE 2 may transmit the CQI information, however for the second allotted time period after the completion of 1 cycle, the UE 2 may transmit user traffic. Therefore, it would be appreciated that the utilization of the time multiplexed E-DCH resource may also vary from one UE 104 to another.

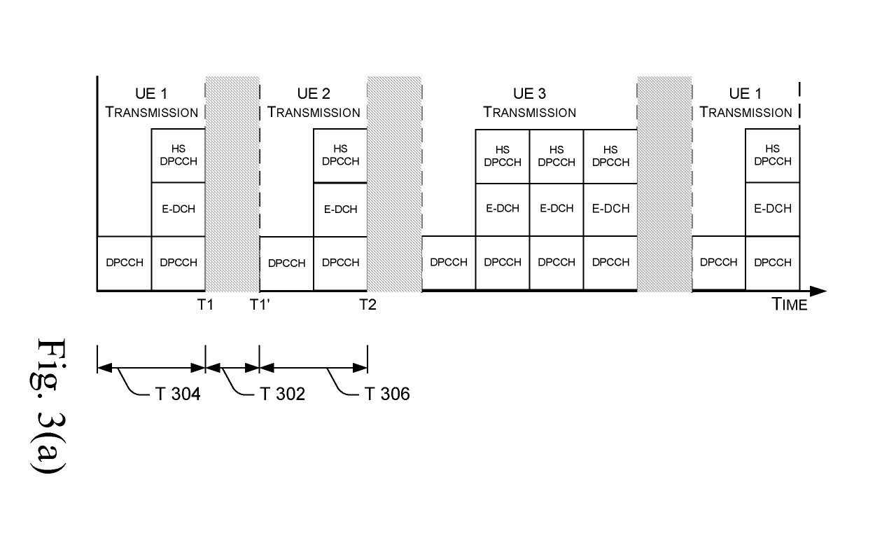

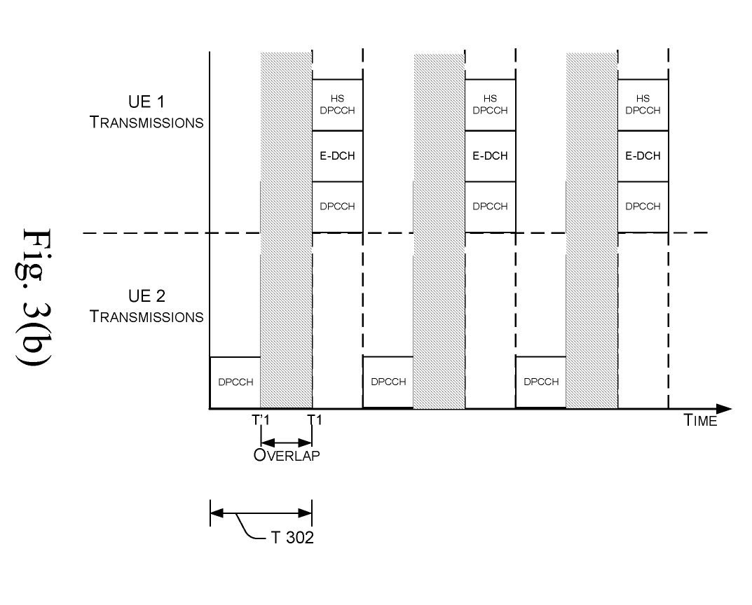

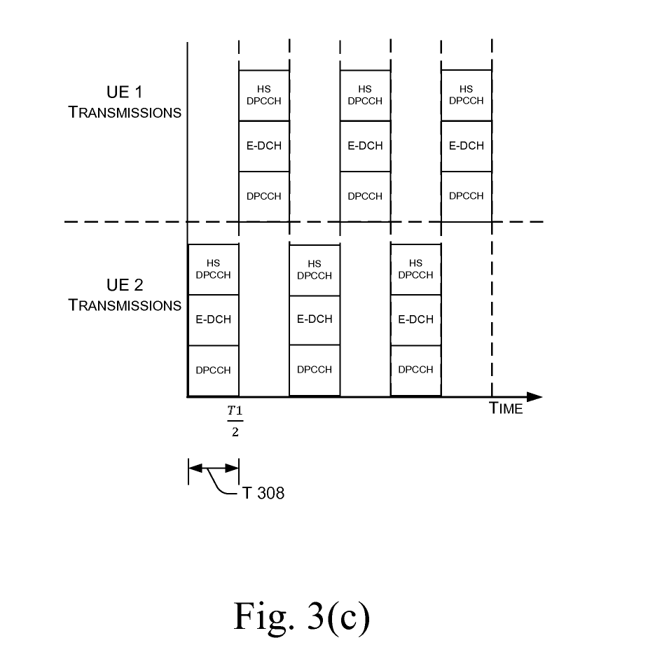

The description of FIGS. 3(a), 3 (b), and 3 (c) illustrates different methods of utilizing an E-DCH resource shared among several UEs on a time multiplex basis, in accordance with an embodiment of the present subject matter.

FIG. 3 (a) describes the use of a guard time T 304 that is introduced between the transmissions of two UEs 104 while transmitting over a time multiplexed E-DCH resource. When the uplink resource of E-DCH is shared between several UEs 104, the resource is time multiplexed and particular time slots are accessed by different UEs 104 to transmit the CQI information. The transmissions from two different UEs 104 may not be perfectly aligned due to propagation and processing delay. Hence, a UE's 104 transmission may clash with a NB's 102 reception of a previous UE's 104 transmission. Therefore, the guard time T 302 is provided in between two time slots of the UEs 104 to provide some margin that can handle these delays.

Similar to the transmission of UE 1 in FIG. 2, the UE 1 transmits the data during the time period T 304. The transmission of UE 1 stops at time T1 but, the transmission of UE 2 does not start at the time T1. Rather, the guard time T 302 having a time period T1 to T1′ is introduced where no UE 104 is allowed to transmit data. The time of transmission of UE 2 begins at T1′ for a time period T 306. The guard time T 304 in one implementation of the present subject matter is a multiple of TTIs. However, in another implementation, a guard time T 302 of less than a TTI may also be utilized. It would be understood that the guard time T 302 is not introduced only between the transmission of UE 1 and UE 2, but is introduced between the transmissions of UE 2 and UE 3 as well. Therefore, it would be appreciated that in case of several UEs 104 sharing an E-DCH resource, the guard time T 304 would be introduced between the transmission of each UE 104.

In said embodiment, the UE 2 starts transmission at time T1′ and completes the transmission at T2. It would be evident from the figure that the time allotted for transmission to UE 2 is equal to the time allotted to UE 1. However, for the same time multiplexed E-DCH resource, the time allotted to UE 3 is double the time allotted to UE 1 and UE 2. Although the time period of the guard time T 302 is shown to be equal between the transmissions of all UEs, it would be understood by those skilled in the art that the guard time T 302 between the transmission of UE 1 and UE 2 may be different from the guard time T 302 between the transmission of UE 2 and UE 3, and therefore, the guard time T 302 may not be constant between transmissions of each UE 104.

FIG. 3 (b) depicts a transmissions scheme over the time multiplexed E-DCH resource, in accordance with an embodiment of the present subject matter. The DPCCH transmission of the UE 104 can overlap the transmission of another UE that shares the time multiplexed E-DCH resource. Such transmission may be referred to as overlap mode transmission hereinafter. According to the figure, the time multiplexed E-DCH resource is shared among two UEs, UE 1 and UE 2. The UE 1, while accessing its time period T 302, terminates the transmission at time instance T1. However, the transmission of UE 2 does not start at time instance T1, but instead, the UE 2 starts its transmission at time instance T′1.

As is evident from the figure, the time instance T′1 occurs before T1 (or T′1<T1) and therefore, the transmission of UE 2's DPCCH overlaps with the DPCCH transmission of UE 1. Since, during the time period T 302, the NB 102 would receive the DPCCH data from two UEs 104, UE 1 and UE 2, in order to distinguish between DPCCH of a UE1 and a UE2, a different channelization code or an orthogonal pilot is utilized by each of the UE 104. The use of orthogonal pilot or different channelization code allows a clear distinction between the transmissions of the two UEs and may enable higher efficiency whilst using the same uplink resource. This may allow the E-DCH to be more efficiently packed and thereby providing higher utilization.

FIG. 3 (c) describes yet another scheme of transmission over the time multiplexed E-DCH resource, in accordance with an embodiment of the present subject matter. In an implementation a standalone DPCCH is not transmitted prior to the transmission of E-DCH and HS-DPCCH by any of the UEs. Methods utilizing such transmission may be referred to as compact mode transmission hereinafter.

As depicted in the figure, the transmission of UE 1 terminates after the allotted time period T 308. During this allotted time period, the UE 1 does not transmit the DPCCH prior to the transmission of data and therefore, the transmission of UE 1 ends at time instance T1/2. The time period T 308 of transmission for UE 1 is reduced by half in this case, however the reduction of time period T 308 may always not be by a factor of 2 and may only be limited to the time used by the UE 104 to transmit the DPCCH. This method of transmission is useful if the period between two transmissions of the UE 104 is short and the condition radio link does not change significantly. In such a situation the pre-transmission of DPCCH may not add significant value to the subsequent transmission of E-DCH and HS-DPCCH at hence can be omitted. The implementation of such a transmission scheme may fully utilize the resource for actual traffic transmission.

FIG. 4 illustrates a pattern 400 in which a common E-DCH resource is time multiplexed and shared among multiple UEs, in accordance with an embodiment of the present subject matter.

As explained before, the pattern 400 of sharing a common E-DCH resource is provided by the NB 102 to the multiple UEs 104 that are sharing the resource. In the pattern, the NB 102 provides the cycle of the E-DCH resource to the UE 104. The cycle of the E-DCH resource may represent the duration after which a UE can access the time multiplexed E-DCH resource to transmit data. The NB 102 would also notify the duration of the availability of the resource during each cycle to the UE 1 in the pattern of sharing. In other words, the NB 102 notifies the UE 1 that during each cycle, how many time periods can be utilized by the UE 1 to transmit data.

Further, in the pattern of sharing, the NB 102 also notifies the offset of the UE 1 where the transmission of UE 1 in each cycle should start. This enables the UE 1 to exactly identify the time periods at which it can transmit data.

In one example depicted in FIG. 4, a E-DCH resource is multiplexed between three UEs, UE 1, UE 2, and UE 3. Since the UEs share the same E-DCH resource, the pattern of sharing for each UE is different from the other. The UE 1 has a cycle of 8 frames where each frame is equivalent to one time period, the cycle of UE 1 is represented by C1 in the figure. Similarly the UE 2 has a cycle of 16 frames represented by C2 in the figure. The UE 3 transmits user data over the shared E-DCH resource in the time periods unutilized by UE 1 and UE 2. UE 1 transmissions during T_{UE1} and the UE 2 transmissions during T_{UE2} are shown in the figure and follow a Discontinuous Transmission (DTX) cycle as notified by the NB 102. The NB 102 has assigned the time period of the E-DCH resource corresponding to the DTX cycle of UE 1 and UE 2 to the UE 3. UE 3 uses the radio frames that are not used by UE 1 and UE 2 to transmit data over the E-DCH resource and hence, the resultant time multiplexed E-DCH resource is utilized efficiently. For the sake of clarity, the frames when each UE transmits data over the uplink have been shown in black, and the frames for which the UEs do not transmit data over the uplink are shown in white. In the said embodiment, the NB 102 has neither implemented a guard time T 302, nor do the UEs follow the scheme of overlapping transmissions. The UE 1 has a cycle of 8 frames and the duration of transmission is 1 frame. Similarly, the UE 2 transmits for a duration of 1 frame but follows a cycle of 16 frames. It would be understood that the offset in the depicted situation for UE 1 would be 0 frame(s) and for UE 2 would be 1 frame(s).

Again, it would be understood by those skilled in the art that during the transmission in respective allotted frames by the UEs, the data transmitted over the uplink may or may not include the CQI information and, the uplink transmission by the UEs may include user traffic other than CQI. Also, it would be appreciated that the UEs may implement any of the described methods of transmission including overlap transmissions, transmissions without introductory DPCCHs, and the like without departing from the scope and the spirit of the subject matter described.

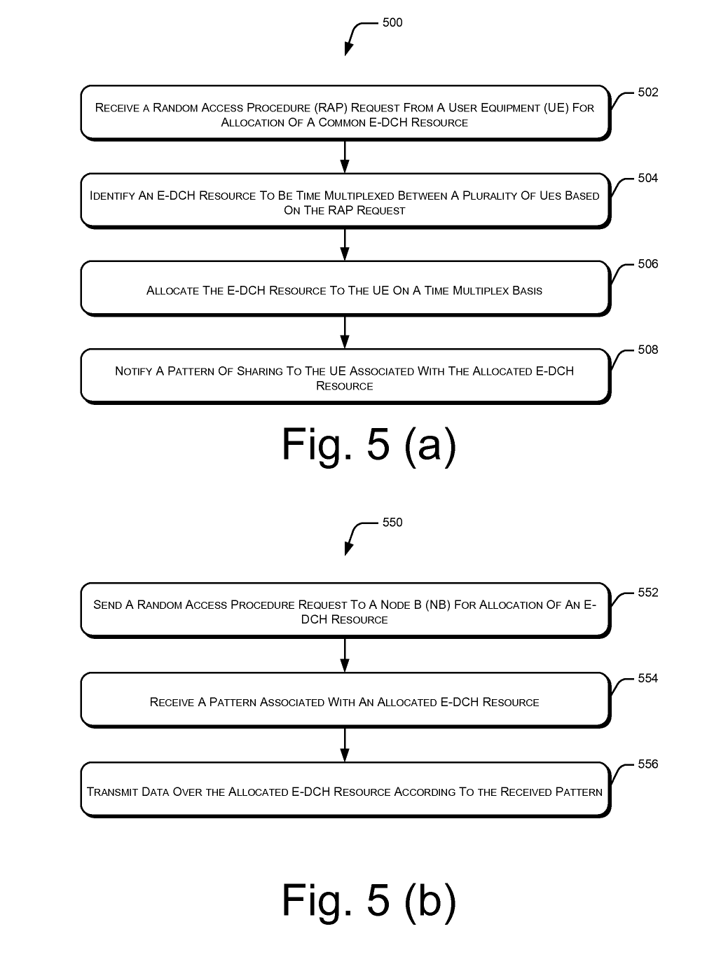

FIG. 5 (a) illustrates an exemplary method 500 for allotting a time multiplexed E-DCH resource to a UE, in accordance with an embodiment of the present subject matter and FIG. 5 (b) illustrates an exemplary method 550 for data transfer on a E-DCH resource shared among several UEs on a time multiplex basis, in accordance with another embodiment of the present subject matter. The order in which the methods 500 and 550 are described is not intended to be construed as a limitation, and any number of the described method blocks can be combined in any order to implement the methods 500 and 550, or an alternative method. Additionally, individual blocks may be deleted from the methods 500 and 550 without departing from the spirit and scope of the subject matter described herein. Furthermore, the methods 500 and 550 may be implemented in any suitable hardware, software, firmware, or combination thereof.

A person skilled in the art will readily recognize that steps of the methods 500 and 550 can be performed by programmed computers. Herein, some embodiments are also intended to cover program storage devices, for example, digital data storage media, which are machine or computer readable and encode machine-executable or computer-executable programs of instructions, wherein said instructions perform some or all of the steps of the described methods 500 and 550. The program storage devices may be, for example, digital memories, magnetic storage media such as a magnetic disks and magnetic tapes, hard drives, or optically readable digital data storage media. The embodiments are also intended to cover both communication network and communication devices configured to perform said steps of the exemplary methods 500 and 550.

With reference to method 500, as depicted in FIG. 5 (a), as illustrated in block 502, a Node B (NB), such as a NB 102, may receive a random access procedure (RAP) request from a user equipment (UE), such as a UE 104-1 for allocation of an E-DCH resource. The RAP may include a preamble describing the request for allocation of an E-DCH resource. It would be understood by those skilled in the art that the NB 102 is configured to identify the RAP request and determine the resource requested for, such as RACH or the E-DCH.

At block 504, the NB 102 may identify an E-DCH resource to be time multiplexed between a plurality of UEs 104, based on the received RAP request. Among all the available common E-DCH resources, the NB 102 may divide the resources into two sets where, a first set of E-DCH resources may be utilized for the purpose of bursty traffic handling and a second set of E-DCH resources may be shared among a plurality of UEs 104 on a time multiplex basis. The NB 102 may identify an available E-DCH resource from the second set of resources to be shared among a plurality of UEs 104.

At block 506, the NB 102 allocates the E-DCH resource to the UE 104-1 on a time multiplex basis. The E-DCH resource identified at block 504 is allocated to the UE 104-1 for the purpose of transmitting data in the uplink through the allocated E-DCH resource. It would be understood that the allocated E-DCH resource is shared among a plurality of UEs and may be available to the UE 104 for a certain time period on a cyclic manner. Since the allocated E-DCH resource would be available to the UE on a cyclic manner, the UE may utilize the allocated E-DCH resource for recursive and consistent transmission of CQI information.

At block 508, the NB 102 notifies a pattern of sharing to the UE associated with the allocated E-DCH resource. The E-DCH resource is shared among multiple UEs and therefore, each UE requires a comprehensive detail about the time periods or the time instances when the resource could be accessed for the purpose of data transmission by the UE. For this purpose, the NB notifies the UE, such as the UE 104 of a pattern which includes the cycle of the resource, the duration of the availability of the resource during each cycle, and the offset where the transmission in each cycle should start for the UE 104. Hence, the pattern notified by the NB 102 to the UE 104 allows the E-DCH to be shared among a plurality of UEs on a time multiplex basis.

With reference to method 550, as depicted in FIG. 5 (b), at block 552, a UE, such as the UE 104-1, sends a random access procedure (RAP) request to a Node B (NB) for allocation of an E-DCH resource. As described earlier, the UE may transmit a preamble along with the RAP request to allow the NB to assess the nature of the request. The UE may transmit a different preamble to request for a RACH resource whereas may send a different preamble to request for an E-DCH resource. Upon receiving a preamble corresponding to an E-DCH resource a NB, such as the NB 102, identifies that the UE 104-1 has requested for allocation of an E-DCH resource and, in accordance with one embodiment, may choose to allocate a time multiplexed E-DCH resource to the UE 104-1.

At block 554, the UE may receive a pattern associated with a time multiplexed E-DCH resource allocated by the NB 102 to the UE 104. The NB, may allocate a E-DCH resource that is time multiplexed among a plurality of UEs to the UE, such as the UE 104. Therefore, for the correct identification of the time instances when an access to the allocated E-DCH resource is allowed, the UE 104 receives a pattern of sharing of the resource. As already described, the pattern of sharing may include cycle of the resource, the duration of the availability of the resource during each cycle, and the offset where the transmission in each cycle should start, based on which the UE may identify the correct time periods when the resource is available and the UE 104 is allowed transmissions on the resource.

At block 556, the UE 104 transmits data over the allocated E-DCH resource according to the received pattern. The UE 104 may transmit CQI information over the uplink. Since the E-DCH resource is time multiplexed among several UEs and is available to each UE after every pre-determined cycle, the E-DCH resource shared among the UEs may be best utilized for the purpose of recursive and consistent CQI transmissions.

Although implementations for sharing a E-DCH resource among several UEs have been described in language specific to structural features and/or methods, it is to be understood that the appended claims are not necessarily limited to the specific features or methods described. Rather, the specific features and methods are disclosed as exemplary implementations for time multiplexing a E-DCH resource in a UMTS.

1. A method for sharing common enhanced uplink dedicated channel, E-DCH, resources, the method comprising:
receiving, from a user equipment, UE, a random access procedure, RAP request for allocation of an E-DCH resource from amongst a plurality of common E-DCH resources;
identifying the E-DCH resource to be shared on a time multiplex basis amongst a plurality of UEs based on the RAP request; and
allocating the identified E-DCH resource to the UE on a time multiplex basis, wherein the E-DCH resource is shared amongst the UE and one or more UEs from amongst a plurality of UEs, wherein the identifying the E-DCH resource comprises distributing E-DCH resources into a first set of legacy E-DCH resources and a second set of E-DCH resources, wherein the second set of E-DCH resources are time multiplexed.

2. The method as claimed in claim 1, wherein the method further comprises receiving, from the UE, a channel quality indication, CQI, in a high speed dedicated physical control channel, HS-DPCCH, on the allocated E-DCH resource, and wherein the CQI is indicative of communication quality of a radio link.

3. (canceled)

4. The method as claimed in claim 1, wherein the method further comprises notifying a pattern of sharing associated with the allocated E-DCH resource to the UE.

5. The method as claimed in claim 4, wherein the pattern of sharing the allocated E-DCH resource comprises one or more of a cycle of the E-DCH resource, a duration of the availability of the E-DCH resource during each cycle, and an offset where the transmission in each cycle should start.

6. The method as claimed in claim 4, wherein the method further comprises receiving data on the allocated E-DCH resource based on the notified pattern.

7. The method as claimed in claim 4, wherein the pattern comprises a time guard between transmissions of each of the plurality of UEs.

8. A user equipment, UE, comprising:
a UE uplink control module configured to send a random access procedure, RAP, request to a Node B, NB, for allocation of a common enhanced uplink dedicated channel, E-DCH, resource; and
a UE configuration module configured to receive a pattern associated with an allocated E-DCH resource, wherein the allocated E-DCH resource is time multiplexed among a plurality of UEs, wherein E-DCH resources are divided into a first set of legacy E-DCH resources and a second set of E-DCH resources, wherein the second set of E-DCH resources are time multiplexed.

9. The UE as claimed in claim 8, wherein the UE uplink control module is further configured to transmit data over the allocated E-DCH resource according to the pattern, and wherein the data is at least one of a channel quality indication, CQI, data and a user traffic data.

10. The UE as claimed in claim 8, wherein the UE uplink control module is further configured to transmit CQI in a high speed dedicated physical control channel, HS-DPCCH, over the allocated E-DCH resource, and wherein the allocated E-DCH resource only includes an enhanced uplink dedicated channel radio network temporary identifier, E-RNTI.

11. The UE as claimed in claim 8, wherein the UE uplink control module is further configured to send a RAP request to a Node B, NB, for allocation of another legacy E-DCH resource.

12. The UE (104) as claimed in claim 8, wherein the UE uplink control module is further configured to transmit data in parallel over the time multiplexed allocated E-DCH resource and another legacy E-DCH resource from the first set.

13. The UE as claimed in claim 8, wherein the UE uplink control module is further configured to transmit data in one of overlap mode and compact mode.

14. The UE as claimed in claim 10, wherein the UE uplink control module is further configured to transmit high speed downlink shared channel radio network temporary identifier, H-RNTI, in the HS-DPCCH.

15. A Node B, NB, for sharing common enhanced uplink dedicated channel, E-DCH, resources, the NB comprising:
a resource allocation module configured to:
receive, from a user equipment, UE, a random access procedure, RAP, request for allocation of an E-DCH resource from amongst a plurality of common E-DCH resources;
identify the E-DCH resource to be shared on a time multiplex basis amongst a plurality of UEs based on the RAP request; and
allocate the identified E-DCH resource to the UE on a time multiplex basis, wherein the E-DCH resource is shared amongst the UE and one or more UEs from amongst a plurality of UEs, wherein the resource allocation module is further configured distribute E-DCH resources into a first set of legacy E-DCH resources and a second set of E-DCH resources to identify the E-DCH resource, wherein the second set of E-DCH resources are time multiplexed.

16. The NB as claimed in claim 15, wherein the resource allocation module is further configured to receive, from the UE, a channel quality indication, (CQI) in a high speed dedicated physical control channel (HS-DPCCH) on the allocated E-DCH resource, and wherein the CQI is indicative of communication quality of a radio link.

17. (canceled)

18. The NB as claimed in claim 15, wherein the NB further comprises a sharing pattern control module, coupled to the resource allocation module (114), configured to notify a pattern of sharing associated with the allocated E-DCH resource to the UE, and wherein the pattern of sharing comprises one or more of a cycle of the E-DCH resource, a duration of the availability of the E-DCH resource during each cycle, and an offset where the transmission in each cycle should start.

19. The NB as claimed in claim 18, wherein the resource allocation module is further configured to receive CQI data over the allocated E-DCH resource according to the pattern, and wherein the allocated E-DCH resource only includes an enhanced uplink dedicated channel radio network temporary identifier, E-RNTI.

20. A computer-readable medium having embodied thereon a computer program for executing a method comprising:
identifying a plurality of user equipments, UEs, for sharing an enhanced dedicated channel, E-DCH, resource, wherein the sharing is done on time multiplexing basis;
determining a pattern of sharing associated with the E-DCH resource, wherein the pattern comprises one or more of a cycle of the E-DCH resource, a duration of the availability of the E-DCH resource during each cycle, and a offset where the transmission in each cycle should start; and
notifying the pattern of sharing to the plurality of UEs sharing the E-DCH resource.
